(19) United States
(12) Patent Application Publication
(10) Pub. No.: US 2007/0223793 A1
(43) Pub. Date: Sep. 27, 2007

(54) Systems and methods for providing diagnostic imaging studies to remote users

(76) Inventor: Abraham Gutman, Chestnut Hill, MA (US)

Correspondence Address: BROMBERG & SUNSTEIN LLP, 125 SUMMER STREET, BOSTON, MA, 02110-1618, US

(21) Appl. No.: 11/335,244

(22) Filed: Jan. 19, 2006

(51) Int. Cl. G06Q 10/00; G06K 9/00

(52) U.S. Cl. 382/128; 705/2

(57) ABSTRACT

Systems and methods for the distribution of diagnostic imaging studies include a first translator electrically coupled to an imaging device, the first translator being arranged an configured to receive an diagnostic imaging study from the imaging device, compress and encrypt the diagnostic imaging study, and transfer the diagnostic imaging study to one or more additional translators substantially simultaneously. The system may also include a second translator, the second translator being arranged and configured to decrypt and decompress the diagnostic imaging study and a network, coupled between the first translator and the second translator, the network being arranged to transfer the diagnostic image study from the first translator to at least the second translator.

### CROSS REFERENCE TO RELATED APPLICATIONS

This application is related to U.S. patent application Ser. No. ______, entitled Systems and Methods for Obtaining Readings of Diagnostic Imaging Studies, filed on even date herewith.

### TECHNICAL FIELD AND BACKGROUND ART

The present invention relates to the transport and distribution of diagnostics image studies and, in particular, to the electronic distribution of diagnostic image studies to remote users.

It is known in the prior art to utilize the Digital Imaging in Communication and Medicine (DICOM) standard to electronically transfer diagnostic imaging studies from a modality or PACS (Picture Archiving and Communications System) (also referred to herein as an imaging device) (both of which may be referred to as an “imaging device” herein) to a remote user. Examples of modalities include CAT scanners, X-ray machines, and MRI machines. The output of these devices may be referred to herein as a “diagnostic imaging study”. In many cases the diagnostic imaging study will include one or more images. In many cases, the diagnostic imaging study will contain several images.

Typically, images from the modality are initially stored to a Picture Archiving and Communications System (PACS) located in the network of the company (or hospital) that is operating the modality. A PACS is a system that acquires, transmits, stores, retrieves, and displays digital images and related patient information from a variety of imaging sources and communizes the information over a network.

A PACS, operating upon medical image databases, almost universally complies with the DICOM standard. DICOM is the widely accepted standard for digital medical data representation, encoding, storage, and networking. The DICOM standard is specified in fourteen (14) volumes (traditionally numbered as PS3.1-PS3.14), available from National Electrical Manufacturers Association (NEMA) and is well known to those working in the digital medical imaging area. The standard provides strict guidelines for medical digital imaging, and is supported by virtually all present medical system manufacturers. The DICOM standard is object-oriented and represents each information entity as a set of Data Elements (such as Patient Name, Image Width) with their respective values encoded with DICOM Dictionary. Typically, the DICOM standard stores and utilizes raw picture data, which is a very low level method of capturing images. These images require a great deal of storage space and, therefore, may be difficult to transmit electronically from one location to another due to their size. In addition, the size of these files increases the time required to transmit them and, thus, may tie up communication lines for extended periods of time and reduce the efficiency by which interpretations of the images may be obtained.

Existing PACS, however, have included methods of compression, such as the well-known Joint Photographer Experts Group (JPEG) algorithm in order to reduce the size of the image files. The JPEG algorithm is, however, “lossy,” meaning that the decompressed image that has been compressed by the algorithm isn't quite the same as the original. As such, many DICOM web-based viewers using the JPEG algorithm may be unacceptable to an interpreter needing to provide conclusive diagnostic level interpretations. Indeed, because the JPEG algorithm is lossy, an individual reviewing an image that has been compressed with the JPEG algorithm may not be able see important features of the image. This loss of features may be unacceptable to those, for example, in the medical community when reviewing diagnostic imaging studies.

Lossless compression is naturally a more limited form of compression since it is necessary to preserve all information in the image. Because the degree of compression is more limited, there is a need in the relevant art to provide more efficient methods of lossless compressing image data. Understandably, doing so may require proprietary methods and prevent exchanges between systems from different vendors. As such, hospitals or other operators utilizing lossless compression may be limited in the number of vendors for imaging devices and PACS and, to have effective communication, all users of the system needing to examine/interpret the diagnostic imaging studies may be required to utilize the same hardware and/or proprietary compression/decompression software. This may not be a problem in “closed” environments, but as soon as the need exists to transfer images to an individual outside the environment (for example, a doctor at another hospital), it may be difficult or impossible to effectively send lossless compressed image data to that individual.

PACS are often implemented on network systems, such as Local Area Networks (LANs), and include a server system controlling the transfer of medical image data from storage devices to multiple viewing stations within the LAN or other network system. These systems are limited, however, in the case of a remote user, defined as a user who is outside of the local area network.

Many PACS provide for the viewing of images using either web-based viewers or specialized Java Applets. The impact of this on the interpreting individual (for example, a radiologist or other doctor) is that if the images arrive fast, then they are of low resolution. If they need to be of high resolution, then they will arrive much slower, or require all parties to share the same vendor system, thus limiting the number of physician relationships and access to specialists that a hospital or imaging center can have.

In addition, transfer of images from a PACS to a remote location typically requires a point-to-point transfer. That is, the PACS may require a direct connection to the receiver. If this point-to-point connection is interrupted, DICOM requires that the entire study be resent. This severely slows the effective rate at which studies may be sent to an individual interpreter. Furthermore, in the case where it is desired to send the study to multiple individuals, for example to have several individuals interpret a study, each person would have to have a direct connection to the PACS of another user (or interface) that has a direct connection to the PACS. Moreover, the transfers would need to be sent sequentially, rather than concurrently and require the sender to send each study to each recipient individually.

Some PACS do allow for pushing of images from the PACS to a remote user and thus may avoid having to implement DICOM in that transfer of images. Such systems require, however, that the user have a viewer that is made by the same manufacturer as the PACS itself (such systems may use proprietary compression). As such, users that are remote are bound by a single supplier for a PACS and a viewer and also a point to connection to each one. This problem may be exacerbated if the remote user is from a different hospital than where the PACS is located thus, making it more difficult to ensure that the remote user has a viewer that is compatible with a particular PACS. In addition, these systems do not allow for the concurrent transfer of images.

Limiting the number of persons who may interpret images may severely reduce the profitability of a particular modality (imaging device) as well as access to qualified specialists for a particular patient.

Limiting the number of specialists may also effect the profitability of an operator of an imaging device. This effect may come from billing requirements imposed upon the operator of the modality. In particular, the operator is not allowed to charge for a procedure until a final interpretation of the images has been completed.

### SUMMARY OF THE INVENTION

Embodiments of the present invention may solve one or more of the above mentioned limitations of the prior. For instance, some embodiments of the present invention may allow for point to multipoint distribution of diagnostic imaging studies. Some embodiments may allow a recipient of diagnostic imaging studies to more quickly receive images from a single source or from multiple sources simultaneously. In addition, embodiments of the present invention may allow for diagnostic imaging studies to be simultaneously sent from a single location to multiple locations and, thus, may allow of multiple individuals to simultaneously interpret the same images. This may be advantageous, for example, as a quality control mechanism to verify a diagnosis (i.e., a substantially simultaneous “second opinion”).

A first embodiment of the invention provides a system that includes a translator that receives diagnostic imaging studies from an imaging device. In one embodiment, the translator may be coupled to the imaging device via a local area network. The translator may include software, hardware, or a combination of both, that may compress and encrypt images received from the imaging device. In a particular embodiment, the translator may perform bitwise compression on the images. This embodiment may also include a central receiver (coupled to the translator) that may receive and store the compressed and encrypted images. In one embodiment, the central server may be coupled to the translator via a communications network, such as the Internet or other communications networks.

In some embodiments, the compressed and encrypted images may be sent to one or more individuals that have a translator and a viewer. The translator these one or more individuals have may have hardware, software, or a combination of both that may decrypt and decompress the diagnostic imaging study and its components. This may allow individual to interpret the diagnostic image study by viewing them on the viewer. In some embodiments, the central server may cause the images to be sent to several individuals simultaneously, or substantially instantaneously, thus allowing for point to multipoint distribution of the images and thereby, reducing the time and expense for sending such images. In some embodiments, the encryption may be specific for a given individual.

The foregoing features of the invention will be more readily understood by reference to the following detailed description, taken with reference to the accompanying drawings, in which:

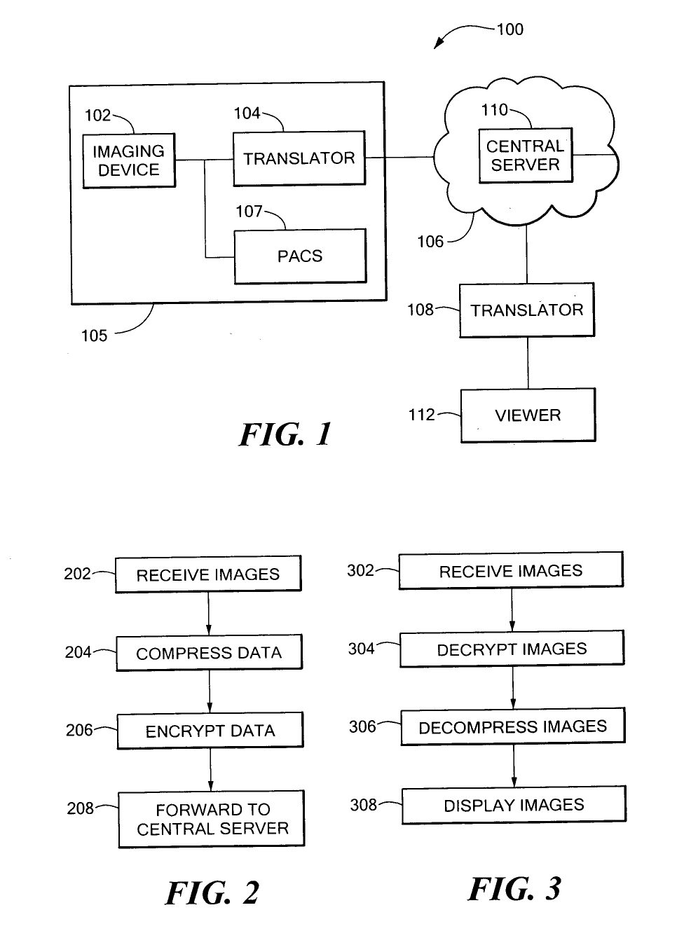

FIG. 1 is an example of a system on which embodiments of the present invention may be implemented;

FIG. 2 is a flowchart showing one embodiment the process that occurs in the translator;

FIG. 3 shows an embodiment of the operations that may be performed in the second translator;

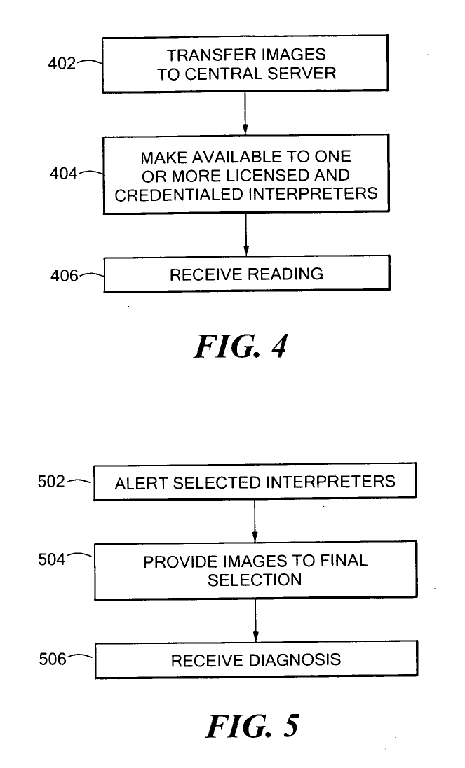

FIG. 4 is a flow diagram showing one embodiment of distributing image data; and

FIG. 5 is a flow diagram by which the operator of an imaging device may get one or more interpretations of a study.

### DETAILED DESCRIPTION OF SPECIFIC EMBODIMENTS

Referring now to FIG. 1, in some embodiments of the present invention, the system 100 may include imaging device 102. Of course, an imaging device is not required and the system may receive images from any source. This imaging device 102 may be any type of modality that may take diagnostic images of a patient. For example, the imaging device 102 may be an MRI machine, a digital X-ray machine, a CAT scan machine or any other type device. In other embodiments, the imaging device 102 may be any type of imaging device whether or not it is used for a diagnostic image of the human or not. For instance, the imaging device 102 could be an electron microscope or the like. The imaging device 102 transfers the images to other devices in the internal network 105 at the location where the imaging device 102 is located. For instance the internal network 105 could be a local area network (LAN) that has a plurality of devices connected to it. For instance, the imaging device 102 could be connected via the internal network 105 to a translator 104 and a PACS 107. As shown the network is connected to a PACS 107. Of course, this element is optional and could be omitted or other elements could be coupled to the network 105, or the imaging device 102 could transfer the diagnostic imaging study to a PACS 107 which in turn transfers it to the translator 104.

Typically, an imaging device 102 will transfer the information, via the DICOM standard. As is well known, the DICOM standard requires that while a transfer is occurring, the systems at both ends need to be part of the transaction, and must be there throughout the transaction. The transfer transactions (DICOM push/pull) are very detailed and require interaction of the systems for each study image being transmitted. In addition, the DICOM standard requires that the imaging device provide all of the images to whatever destination is selected. If an imaging device is attempting to send the pictures/images to a remote site, the transportation of the images may tie up the imaging device for a substantial amount of time if the connection between the external device and the imaging device 102 is not robust. That is, if the imaging device 102 cannot get confirmation that each and every image was transferred to the receiving device, the imaging device may not move on to the next procedure until all of those images are transferred. This, in turn, may lead to delays in the operation of the imaging device and therefore increase the time of patient care and, possibly, reduce the profitability of imaging device 102 because the profitability of such of a device increases as the number of studies may increase.

In the system 100 as shown in FIG. 1 some of these problems may be substantially reduced. For instance, the imaging device 102 is connected through a local area network, in some embodiments, to a translator 104 as well as a PACS 107.

The translator 104, in one embodiment, compresses the stream of diagnostic imaging data, as well as any data associated therewith and then encrypts the data. In preferred embodiment, the compression is lossless.

The translator 104 may include a central processing unit (CPU) having a conventional microprocessor, random access memory (RAM) for temporary storage of information, and read only memory (ROM) for permanent storage of read only information. A memory controller is provided for controlling system RAM. In one embodiment, the translator 104 does not store any data to memory until it is encrypted regardless of whether it has been compressed.

Mass storage may be provided by known non-volatile storage media, such as a, a digital versatile disk (not shown), a CD-ROM, or a hard disk. Data and software may be exchanged with the translator 104 via removable media, such as a diskette or a CD-ROM or be downloaded via the internet or other connective network.

The translator 104 system preferably is controlled and coordinated by operating system software such as Linux or DOS. Among other computer system control functions, the operating system controls allocation of system resources and performs tasks such as process scheduling, memory management, networking, and I/O services.

A network adapter also may be included to enable the translator 104 to be interconnected to a network, such as the internet 106 and LAN 105 or a dedicated wide area network. The network, which may be a local area network (LAN), a wide area network (WAN), or the Internet, may utilize general purpose communication lines that interconnect a plurality of network devices.

After compression and encryption are completed, the images, in one embodiment, may be forwarded to the central server 110 to which the translator may connect through the Internet 106 or through a private network. In an illustrative embodiment, an operator of the imaging device 102 will select which doctors or other interpreters may have access to the images in a particular study. That information dictates where and how the information is stored in the central server 110. For instance, each doctor may have an account at the central server 110, or each file may be encrypted in such a manner that only particular doctors who are authorized to see the images may access the information on the central server 110. Advantageously, because the information is now compressed and encrypted in such a way as to make it possible to transport it using protocols other than DICOM, the information is no longer subject to the DICOM requirements of image by image protocol. Therefore, doctors may have access to the diagnostic quality images much more quickly, and more doctors can have access to the information in a completely flexible manner. In one embodiment, the translator may direct the central server (based on information received with the diagnostic imaging study) where to study should be further sent without the need for any intervention from the recipient(s) to whom the study was sent.

The system may also include an additional translator 108, which decrypts and decompresses the information before it is viewed by the device 112 (referred to herein as a viewer) used by the interpreter to view the images associated with the diagnostic imaging study. This additional translator 108 should be able to decrypt the data and then decompress the data such that a perfectly lossless representation of the original DICOM compliant data is delivered to the viewer by the additional translator 108. As such, any viewer 112 or any PACS will be able to display the study. This allows for the many heterogeneous machines such as modalities or PACS from different vendors to effectively communicate without any involvement from the vendors or original manufacturers of the modalities or PACS's. In one embodiment, the additional translator 108 may have the same or similar to capabilities as the translator 104 and vice-versa.

FIG. 2 is a flowchart showing one embodiment the process that occurs in the translator 104. As shown, the process includes steps performed in a specific order and includes a specific number of steps. One of ordinary skill should readily realize that certain steps may be omitted, certain steps may be added, and/or certain steps may be performed in an order that is different from that shown in FIG. 2 (or another flow chart shown herein) without departing from the present invention.

As shown in FIG. 2, the process begins at step 202 where the transmitter 104 receives images from the modality 102. The images may be received in any manner but, typically, they are received via the DICOM protocol. As such, the process of receiving the images, in some embodiments, requires complying with all of the regulations imposed upon DICOM and HIPAA (Health Insurance Portability and Accountability Act of 1996). However, because the translator 104 is located on the same internal network 105 as the imaging device 102 this transfer may be very fast as compared to point-to-point image transmission to a remote location.

After the images are received at step 202, they are then compressed at step 204. In some embodiments, the compression may begin before the entire study is received. In other embodiments, the compression may not begin until the entire has been received. Regardless of when compression begins, in an illustrative embodiment, the images as well as any meta-data associated therewith may be compressed, for example, utilizing a “bitwise” compression scheme. Bitwise compression is well known in the art and may generally be described as applying bitwise logical operators to a strings of bits to create a compressed version of the original string independent of how these strings may be interpreted by any computer software. In one embodiment, the compression may be lossless compression. Of course, other types of compression could be used and are within the scope of the present invention.

After the information is compressed in step 204, the data is then encrypted in step 206. In one embodiment, the data is encrypted using an Assymetrical Encryption System (AES). In such an embodiment, preferably 128-bit encryption is used. Of course, other types of encryption may also be used.

In one embodiment, the operator of the imaging device 102 may be allowed to select certain doctors (or group(s) of doctors) that may view or may be sent the particular study. In such a case, the translator 104 may also encrypt the key to the data using a particular individual or groups public/private pair, thus ensuring that only those individuals may view the study. This aspect may be important to the distribution of studies to certified and accredited doctors as described in further detail below.

After steps 204 and 206 are completed, in one embodiment, the information is stored to a hard drive of the translator 104. Preferably, no data is ever stored to the hard drive of the translator 104 until is has been encrypted, thus, even if the translator is misplaced or otherwise unaccounted for, patient information will not be readily available to anyone other than those who were supposed to access to the information. In other embodiments, the information is not stored to the hard drive of the translator 104 but, rather, is immediately sent to another location, such as the central server 110.

Regardless of whether the information is stored to the hard drive, after encryption (and preferably after lossless compression) the information may then be forwarded to the central server 110 via, for instance, the Internet 106. The information having been translated may be transferred in any manner (e.g., via a packet based connection) to the central server 110 rather than the previously used and cumbersome DICOM protocol. The central server 110 may interpret the information that is received and forward the study to specific doctors to whom the operator of the imaging device 102 has previously selected. In this manner, the system may allow for simultaneous point (the imaging device or PACS) to multipoint (multiple individuals) distribution of diagnostic images.

To ensure safety and privacy, as well as to comply with HIPAA, the data (or the key to the data) may be further encrypted using the doctor's public/private key. Of course, many other methods of ensuring safety may be implemented and anything that will ensure the compliance with HIPAA is preferred.

Of course, the reverse of steps 204 and 206 may be completed in the second translator 108 as shown in FIG. 3. For instance, the second translator 108 could decrypt and decompress the data so that all the images of a particular study could be displayed on a viewer 112, for example.

FIG. 3 shows an embodiment of the operations that may be performed in the second translator 108. The process includes a step of receiving the encrypted and compressed images at step 302. In one embodiment, the images may be received from a central server 110. In other embodiments, the images may be received from another location such as, for example, a PACS or an imaging device. The images are then decrypted at step 304 and then decompressed and step 306. As one of ordinary skill in the art will readily realize, many types of decompression and decryption techniques may be used. Finally, the images may be displayed, for example, on a viewer 112 at step 308.

The foregoing discussion has provided an example of systems and methods that may allow diagnostic quality images to be transferred from a modality to one or more individuals. This system, and others, may create a platform from which an operator of an imaging device may make available to one or more remote diagnostic image interpreters (for example, doctors, radiologists, cardiologists, or other professionals qualified to interpret diagnostic images) in a safe and efficient manner. In an illustrative embodiment, the images may be made available to interpreters that have been licensed and credentialed to interpret images transmitted by the operator of the imaging device. For example, the images may be transferred to a radiologist that is remote from a hospital when the hospital needs an interpretation of a study (or other collection of images) in a expedited manner but does not have available on-site human resources to accomplish the task. Additionally, this may allow a particular hospital to expand its access to interpreting physicians who also have a translator, while also allowing a single interpreting physician to provide interpretations to several different hospitals, which also have a translator on site.

FIG. 4 is a flow diagram showing one embodiment of distributing image data. In general, FIG. 4 shows steps by which diagnostic images may be distributed to one or more interpreters. At step 402, the images that constitute a study (one or images) are transferred from an imaging device 102 to a central server. For example, and as discussed above, the images could be transferred, after being compressed and encrypted to the central server 110 shown in FIG. 1. Of course, the images need not be either encrypted or compressed. The images are then made available to one or more licensed and credentialed interpreters at step 404. In order for an interpreter to receive the images, under current law, the interpreter must be licensed to practice medicine (for example, by the state medical licensing board) in the state where the studies were created. Also under current law, the interpreter needs to be credentialed by the operator of the imaging device (for example, a hospital or other health care provider) to provide diagnoses related to the study. Of course, if the law were to change, then, possibly, the interpreter would not need to be either credentialed or licensed or either.

FIG. 5 is a flow diagram by which the operator of an imaging device may get one or more interpretations of a study. In one embodiment, the method shown in this flow diagram may facilitate the more timely and cost effective interpretation of diagnostic images. This may be achieved, for example, by allowing licensed and credentialed interpreters to have a marketplace bid on “contracts” to perform diagnostic interpretations. Such a market place may reduce the time for receiving interpretations of diagnostic images. In addition, such a marketplace may also reduce the cost of such readings. For example, rather than having to have an interpreter on staff at a particular imaging center, the imaging center could only pay for the interpretations that it needs. This may be especially beneficial in locations where it may be hard to recruit qualified individuals, or where the cost employing such an individual is too high.

The process begins at step 502 where interpreters that have been selected by the operator of the imaging device are alerted that a diagnostic interpretation is needed. This may be done in any manner. For instance, the interpreter may have an account at, for example, a central server that causes a notification (such as an e-mail, a fax, a page, an instant message or any other means of alerting the interpreter). Of course, the operator of the imaging device may have selected the one or more interpreters from a list of licensed and credentialed interpreters with which the operator has an existing relationship. In some embodiments, the alert may be represented as a possible interpretation placed on a message board accessible by at least the selected persons, or at a location of the doctor who referred the patient to the operator of the imaging device.

The images may be provided to the final selected interpreter at step 504. An interpreter may become the final selected interpreter in at least the following ways: the interpreter that first responds the desire and ability to perform the interpretation is selected; the interpreter that offers the lowest price may be selected; the interpreter that offers the quickest response may be selected. Of course, other criteria may also be used to determine the final selected interpreter. For example, the criteria may include: sub-specialty, years of experience, physical location, availability to the interpreter of specialized hardware or software, and number of previous interpretations by the interpreter.

In addition, the final selected interpreter may include one or more interpreters. For instance, the first two responders could be provided the images in step 504. In some embodiments, the two responders may be locations geographically remote from one another.

The diagnosis (or final read) is then received at step 506. The diagnosis could be received at any number of locations. For instance, the diagnosis could be received at a central server or at a location of the operator of an imaging device.

What is claimed is:

1. A system for the distribution of diagnostic imaging studies comprising:
a first translator electrically coupled to an imaging device, the first translator being arranged and configured to receive an diagnostic imaging study from the imaging device, compress and encrypt the diagnostic imaging study, and transfer the diagnostic imaging study to one or more additional translators substantially simultaneously;
a second translator, the second translator being arranged and configured to decrypt and decompress the diagnostic imaging study; and
a network, coupled between the first translator and the second translator, the network being arranged to transfer the diagnostic image study from the first translator to at least the second translator.

2. A system according to claim 1, wherein the network includes a central server that receives the diagnostic imaging study from the first translator and causes the diagnostic imaging study to be transferred to the one or more additional translators simultaneously, the one or more additional translators including the second translator.

3. A system according to claim 2, further comprising:
a third translator, the third translator being electrically coupled to the network; and
wherein the central server transfers the diagnostic imaging study from to the third translator simultaneously as it transfers the diagnostic imaging study to the second translator.

4. A system according to claim 1, wherein the first translator compresses the diagnostic imaging study before encrypting the diagnostic imaging study.

5. A system according to claim 1, wherein the compression is bit-wise compression.

6. A system according to claim 5, wherein the bit-wise compression is lossless.

7. A system according to claim 1, wherein the encryption is performed using an Assymetrical Encryption System.

8. A system according to claim 1, further comprising a viewer coupled to the second translator.

9. A system according to claim 8, wherein the viewer is manufactured by a different company than the manufacturer of the imaging device.

10. A system according to claim 1, wherein the network is coupled to PACS located at a location of the operator of the imaging device.

11. A system according to claim 10, further comprising a viewer coupled to the second translator, the viewer being manufactured by a different company than the PACS.

12. A system according to claim 1, wherein the diagnostic image study in not stored or transferred unless it has been encrypted.

13. A method of distributing diagnostic imaging studies comprising:
receiving, at a first translator, the diagnostic imaging study from an imaging device;
compressing and encrypting the diagnostic imaging study in the first translator; and
transferring the compressed and encrypted diagnostic imaging study to one or more additional translators substantially simultaneously.

14. A method according to claim 13, wherein transferring includes transferring the imaging study over a network that includes a central server, the central server causing the compressed and encrypted diagnostic imaging study to be transferred to the one or more additional translators simultaneously.

15. A method according to claim 13, wherein the diagnostic imaging study is compressed before it is encrypted.

16. A method according to claim 13, wherein the compression is bit-wise compression.

17. A method according to claim 16, wherein the bit-wise compression is lossless.

18. A method according to claim 13, wherein the encryption is performed using an Assymetrical Encryption System.

19. A method according to claim 13, wherein the diagnostic image study in not stored or transferred unless it has been encrypted.
